(19) United States
(12) Patent Application Publication
(10) Pub. No.: US 2018/0009161 A1
(43) Pub. Date: Jan. 11, 2018

(54) HAND-HELD THREE-DIMENSIONAL DRAWING DEVICE

(71) Applicant: WobbleWorks, Inc., Wilmington, DE (US)

(72) Inventors: Daniel COWEN, Hong Kong (HK); Maxwell BOGUE, Hong Kong (HK); Thomas WALKER, Shenzhen City (CN)

(21) Appl. No.: 15/203,711

(22) Filed: Jul. 6, 2016

(51) Int. Cl. B29C 47/00

(52) U.S. Cl. CPC B29C 64/118; B29C 64/386; B33Y 30/00; B29C 47/0002

(57) ABSTRACT

A hand-held three-dimensional drawing device can include an anti-rotation mechanism that can restrict rotation of a filament moving through the device. The anti-rotation mechanism can have a filament-engaging component in a passage of the anti-rotation mechanism and positioned to engage and restrict rotation a filament extending through the passage. The drawing device can also include a moveable member to control an operation of the drawing device. The moveable member can include a rotatable control mechanism including a portion of an outer profile of a housing of the device. Finally, the drawing device can also include a cover member comprising a portion of an outer profile of housing of the device and positioned adjacent to an actuator to control an operation of the device.

### BACKGROUND

### Field of the Inventions

The present disclosure relates generally to extrusion devices and more particularly, to extrusion devices for three-dimensional drawing.

### Background

Three-dimensional (“3D”) printers can be used to produce 3D items using extruded material. These printers tend to be large, expensive, and their operation requires a computer file, for example, as generated by a computer-aided design program, which determines the item created. Hand-held devices also can be used to create 3D items of extruded material.

For example, U.S. Pat. No. 3,665,158 to Froedge discloses a conventional hand-held extrusion device. A chamber is filled with a granulated solid plastic material and then sealed with a cap. The contents of the chamber are heated to melt the plastic and create pressure within the chamber. A passage leads from the chamber to a rotatable nozzle that blocks flow in a first position and allows flow in a second position. A trigger is attached to the nozzle such that pulling the trigger moves the nozzle to the second position, thereby allowing the molten plastic to be expelled from the nozzle due to the pressure within the chamber. Releasing the trigger allows the nozzle to return to the first position, thereby stopping the flow of plastic. There is no provision to replenish the raw material without shutting off the device or any mechanism to mechanically feed material to the nozzle at a constant rate. In addition, Froedge's system does not provide a means of cooling the extruded material.

### SUMMARY

Improvements to hand-held extrusion drawing devices have been made by Applicant, WobbleWorks. For example, Applicant has developed the 3Doodler device, which appeals to hobbyists, artists, designers, architects, and educational establishments and allows the creation of 3D objects without the restrictions of complicated software or advanced artistic abilities or design training. The 3Doodler is a hand-held device that allows a user to exercise their imagination, exploring new spatial and physical concepts without requiring special technical knowledge or specific skills. In the course of engineering its 3Doodler, the Applicant has addressed major concerns and made significant advances. Compact and easy to use, the 3Doodler can be plugged into a power socket and used immediately. This makes it ideal for freestyle 3D sketching, tracing shapes from templates to make larger architectural structures, the development of spatial skills for educational purposes, or simply a fun tool for arts and crafts enthusiasts wishing to bring 3D printing into the home. As a result, the Applicant has been at the forefront of a revolution in which hand-held 3D drawing devices have been introduced into numerous establishments like never before.

Among some of the improvements disclosed herein, the present application discloses a hand-held 3D extrusion drawing device that uses a plastic filament or feedstock that is melted inside the device and solidifies when extruded from the tip thereof, allowing users to create unique 3D objects by hand.

In accordance with some embodiments, the extrusion device can comprise a drive mechanism that can be used to advance or feed the plastic filament through the extrusion device to be melted and extruded from a tip of the extrusion device. In order to permit the extrusion device to be a compact hand-held assembly, rotary drive mechanisms can be used. Such rotary drive mechanisms can cause the filament to be advanced by engaging the filament using a rotating component.

The rotating component of some embodiments can rotate about an axis that extends oblique relative to a longitudinal axis of the filament. Further, some embodiments can incorporate a rotating component that comprises a screw-type mechanism that rotates about an axis that extends generally parallel relative to a longitudinal axis of the filament. An example of a screw-type mechanism is illustrated in Applicant's co-pending U.S. patent application Ser. No. 14/586,812, filed on Dec. 30, 2014, the entirety of which is incorporated herein by reference.

In accordance with at least some of the embodiments disclosed herein is the realization that in implementing screw-type mechanisms, instead of imparting only a longitudinal motion, the filament can rotate along with the screw-type mechanism, which decreases the efficiency of the drive mechanism. Further, other challenges include the small size of the filament and the need to reduce or decrease the size of the hand-held extrusion device for ease of use.

In addressing some of these challenges, some embodiments of the hand-held extrusion device disclosed herein can comprise an anti-rotation mechanism that can restrict rotation of a filament moving through the extrusion device. Restricting rotation of a filament can, in some embodiments, facilitate engagement of the filament with a drive mechanism to move the filament through the extrusion device with greater control over the speed, direction of travel, and the start and stop of the filament's motion.

Optionally, some embodiments of the hand-held extrusion device disclosed herein can comprise one or more moveable members to control an operation of the extrusion device. The moveable member can, in some embodiments, provide a rotatable control mechanism to permit adjustments to a rate of extrusion of the filament, a filament heat level of a heater, a motor speed, and/or a direction of filament movement through the extrusion device. Further, the movable member can optionally be configured to extend along an outer contour of the extrusion device.

For example, the movable member can comprise one or two rotatable dials positioned along a proximal portion of the extrusion device. The dial(s) can comprise an outer graspable surface that matches a contour of the extrusion device along the proximal portion thereof. Thus, while holding the device with one hand, the user can easily use the other hand to adjust a rate of extrusion of the filament, a filament heat level of a heater, a motor speed, and/or a direction of filament movement through the extrusion device.

Further, some embodiments of the hand-held device disclosed herein can optionally comprise a flexible cover member that can be used to operably control an adjacent actuator to control one or more operations of the extrusion device.

The cover member can, in some embodiments, comprise an actuation surface to interact with an actuator, facilitate orientation of the extrusion device in a hand of a user, and/or reduce heat transfer between the extrusion device and a user.

For example, the cover member can comprise a tubular section of the housing of the device. The cover member can be fitted over a portion of the housing and/or comprise a rigid inner component that interconnects with one or more portions of the housing, such as front and/or rear portions of the housing.

The subject technology is illustrated, for example, according to various aspects described below. Various features of some embodiments of the subject technology are described as numbered clauses (1, 2, 3, etc.) for convenience. These are provided as examples and do not limit the subject technology. It is noted that any of the dependent clauses may be combined in any combination, and placed into a respective independent clause, e.g., clause 1 or clause 5. The other clauses can be presented in a similar manner.

Clause 1. An extrusion device comprising: an inlet, an outlet, and a longitudinal axis between therebetween; a filament travel path extending along the longitudinal axis; a drive mechanism disposed along the travel path for engaging and urging a filament along the travel path; an anti-rotation mechanism disposed along the travel path adjacent to the drive mechanism, the anti-rotation mechanism comprising a filament-engaging component having a contacting portion positioned adjacent to the travel path to restrict rotation of a filament about the travel path as the filament moves by the anti-rotation mechanism; and a heater disposed between the drive mechanism and the outlet to receive the filament from the drive mechanism.

Clause 2. The device of Clause 1, further comprising a housing, wherein the anti-rotation mechanism restricts rotation of the filament relative to the housing.

Clause 3. The device of Clause 1, wherein the anti-rotation mechanism comprises a tubular body, the contacting portion comprising a radial protrusion extending radially toward the travel path to contact the filament and restrict rotation of a filament relative to the anti-rotation mechanism as the filament moves by the anti-rotation mechanism.

Clause 4. The device of Clause 1, wherein the contacting portion comprises at least one surface extending toward the travel path.

Clause 5. The device of Clause 1, wherein the contacting portion extends parallel relative to the travel path.

Clause 6. The device of Clause 1, wherein the contacting portion tapers in cross-section from the filament-engaging component toward the travel path.

Clause 7. The device of Clause 1, wherein the anti-rotation mechanism comprises a plurality of contacting portions.

Clause 8. The device of Clause 1, wherein a cross-sectional opening through the filament-engaging component is smaller than a cross-sectional profile of the filament.

Clause 9. The device of Clause 1, wherein a distance from the contacting portion to an opposing surface of the anti-rotation mechanism is less than a cross-sectional distance between opposing outer surfaces of the filament.

Clause 10. The device of Clause 1, wherein a distance from the contacting portion to an opposing surface of the anti-rotation mechanism is less than a cross-sectional distance between opposing inner surfaces of the drive mechanism.

Clause 11. The device of Clause 1, wherein the drive mechanism is disposed along the travel path between the filament-engaging component and the outlet.

Clause 12. The device of Clause 1, wherein the drive mechanism is rotatable about the longitudinal axis.

Clause 13. The device of Clause 12, wherein the anti-rotation mechanism restricts rotation of the filament relative to rotation of the drive mechanism.

Clause 14. The device of Clause 1, wherein the drive mechanism comprises a helically threaded portion configured to rotate about and engage with an outer surface of a filament.

Clause 15. The device of Clause 1, wherein the drive mechanism comprises a threaded screw.

Clause 16. The device of Clause 1, wherein the drive mechanism comprises an internally threaded tubular member.

Clause 17. An extrusion device comprising: an inlet, an outlet, and a longitudinal axis between therebetween; a filament-engaging first member configured for moving a filament along a travel path when the first member is rotated; a filament-engaging second member restricting rotation of the filament relative to the first member as the first member is rotated; and a heater disposed along a travel path between the filament-engaging first member and the outlet to receive the filament from the filament-engaging first member.

Clause 18. The device of Clause 17, wherein the filament-engaging first member is disposed along the travel path.

Clause 19. The device of Clause 17, wherein the travel path extends along the longitudinal axis.

Clause 20. The device of Clause 17, wherein the filament-engaging second member is disposed along the travel path between the inlet and the filament-engaging first member.

Clause 21. The device of Clause 17, wherein the filament-engaging second member is disposed along the travel path between the filament-engaging first member and the outlet.

Clause 22. The device of Clause 17, wherein the filament-engaging second member comprises a contacting portion positioned adjacent to the travel path to restrict rotation of the filament about the travel path as the filament moves by the filament-engaging second member.

Clause 23. The device of Clause 22, wherein the contacting portion extends parallel relative to the travel path.

Clause 24. The device of Clause 22, wherein the contacting portion tapers in cross-section from the filament-engaging second member toward the travel path.

Clause 25. The device of Clause 22, further comprising a plurality of contacting portions.

Clause 26. The device of Clause 22, wherein a distance from the contacting portion to an opposing surface of the filament-engaging second member is less than a cross-sectional distance between opposing outer surfaces of the filament.

Clause 27. The device of Clause 22, wherein a distance from the contacting portion to an opposing surface of the filament-engaging second member is less than a cross-sectional distance between opposing inner surfaces of the filament-engaging first member.

Clause 28. The device of Clause 17, wherein a cross-sectional opening through the filament-engaging second member is smaller than a cross-sectional profile of the filament.

Clause 29. The device of Clause 17, wherein the filament-engaging second member comprises a tubular body and a contacting portion comprising a radial protrusion extending radially toward the travel path to contact the filament and restrict rotation of a filament relative to the filament-engaging second member as the filament moves by the filament-engaging second member.

Clause 30. The device of Clause 17, wherein the filament-engaging second member comprises at least one surface extending toward the travel path.

Clause 31. The device of Clause 17, wherein the filament-engaging first member is rotatable around the longitudinal axis.

Clause 32. The device of Clause 17, wherein the filament-engaging first member comprises a helically threaded portion configured to rotate and engage with an outer surface of a filament.

Clause 33. The device of Clause 32, wherein the filament-engaging first member comprises a threaded screw.

Clause 34. The device of Clause 32, wherein the filament-engaging first member comprises a threaded tubular member.

Clause 35. An extrusion device comprising: a housing having an inlet, an outlet, and a longitudinal axis between therebetween; a filament travel path extending along the longitudinal axis; a drive mechanism disposed along the travel path for engaging and urging a filament along the travel path toward a heater configured to heat the filament; and a moveable member for controlling a rate of extrusion of a filament out of the outlet.

Clause 36. The device of Clause 35, wherein the moveable member is rotatable relative to the housing.

Clause 37. The device of Clause 35, wherein the moveable member is rotatable about the longitudinal axis.

Clause 38. The device of Clause 35, wherein an outer surface of the moveable member extends adjacent to an outer surface of the housing.

Clause 39. The device of Clause 35, wherein an outer surface of the moveable member, and an outer surface of the housing adjacent to the moveable member, define a continuous profile.

Clause 40. The device of Clause 35, wherein an inner surface of the moveable member comprises a grooved surface configured to mate with a gear.

Clause 41. The device of Clause 35, wherein an inner surface of the moveable member comprises a first portion comprising a groove configured to mate with a gear, and a second portion comprising a smooth surface configured to facilitate movement of the moveable member.

Clause 42. The device of Clause 35, wherein the moveable member comprises a first end proximally of the inlet, a second end proximally of the outlet, and an outer surface that tapers in cross-section from the second end toward the first end.

Clause 43. The device of Clause 35, wherein the moveable member is positioned proximally of the inlet.

Clause 44. The device of Clause 35, wherein the moveable member comprises a first rotatable knob and a second rotatable knob.

Clause 45. The device of Clause 35, wherein the moveable member is pivotable relative to the housing.

Clause 46. The device of Clause 35, wherein the moveable member is slidable relative to the housing.

Clause 47. The device of Clause 35, wherein the moveable member comprises a first button for increasing a rate of extrusion, and a second button for decreasing a rate of extrusion.

Clause 48. The device of Clause 35, wherein the moveable member is disposed adjacent to the inlet of the housing.

Clause 49. An extrusion device comprising: a housing having an inlet, an outlet, and a longitudinal axis between therebetween; a filament travel path extending along the longitudinal axis; a drive mechanism disposed along the travel path for engaging and urging a filament along the travel path toward a heater configured to heat the filament; and an extrusion control mechanism rotatable about an axis and having an outer circumferential surface adjacent to an outer surface of the housing for controlling a rate of extrusion of a filament out of the outlet.

Clause 50. The device of Clause 49, wherein the extrusion control mechanism is rotatable relative to the housing.

Clause 51. The device of Clause 49, the extrusion control mechanism is rotatable about the longitudinal axis.

Clause 52. The device of Clause 49, further comprising a motor, disposed within the housing, in operative communication with the extrusion control mechanism.

Clause 53. The device of Clause 52, wherein the extrusion control mechanism is in operative communication with the motor for controlling the rate of extrusion of a filament.

Clause 54. The device of Clause 49, wherein the outer circumferential surface of the extrusion control mechanism extends adjacent to a circumferential surface of the housing.

Clause 55. The device of Clause 49, wherein the extrusion control mechanism is in operative communication with a potentiometer.

Clause 56. The device of Clause 49, wherein the extrusion control mechanism is in operative communication with the heater for controlling filament heat level of the heater.

Clause 57. The device of Clause 49, wherein the extrusion control mechanism is disposed adjacent to the inlet of the housing.

Clause 58. An extrusion device comprising: a housing comprising a first material and having an inlet, an outlet, and a longitudinal axis between therebetween; a filament travel path extending along the longitudinal axis; a cover member extending adjacent to an outer surface of the housing, a resilient portion of the cover member comprising a second material that is more flexible than the first material; and an actuator positioned adjacent to an inner surface of the cover member and engaged against the resilient portion of the cover member, the actuator configured to control an operation of the device.

Clause 59. The device of Clause 58, wherein the cover member is disposed between the inlet and the outlet of the housing.

Clause 60. The device of Clause 58, wherein the cover member extends circumferentially about the housing.

Clause 61. The device of Clause 58, wherein the cover member comprises a band.

Clause 62. The device of Clause 58, wherein the cover member comprises at least one of a convex or concave outer surface portion extending over the actuator.

Clause 63. The device of Clause 58, wherein the cover member comprises a length that extends along a portion of the housing between the inlet and the outlet.

Clause 64. The device of Clause 58, further comprising a motor configured to facilitate movement of a filament along the travel path.

Clause 65. The device of Clause 58, further comprising a motor configured to control a rate of advancement of a filament along the travel path.

Clause 66. The device of Clause 58, wherein the actuator comprises a first actuator, and the device further comprises a second actuator.

Clause 67. The device of Clause 58, wherein the cover member overlaps the actuator.

Clause 68. The device of Clause 58, wherein the housing comprises a front portion, a central portion, and a rear portion connected along the longitudinal axis to form the housing, wherein the central portion comprises the cover member.

Additional features and advantages of the subject technology will be set forth in the description below, and in part will be apparent from the description, or may be learned by practice of the subject technology. The advantages of the subject technology will be realized and attained by the structure particularly pointed out in the written description and embodiments hereof as well as the appended drawings.

It is to be understood that both the foregoing general description and the following detailed description are exemplary and explanatory and are intended to provide further explanation of the subject technology.

### BRIEF DESCRIPTION OF THE DRAWINGS

Various features of illustrative embodiments of the inventions are described below with reference to the drawings. The illustrated embodiments are intended to illustrate, but not to limit, the inventions. The drawings contain the following figures:

FIG. 1 is a front perspective view of an extrusion device, according to some embodiments.

FIG. 2 is a rear perspective view of an extrusion device, according to some embodiments.

FIG. 3 is an exploded side view of an extrusion device, according to some embodiments.

FIG. 4 is a cross-sectional view of an extrusion device, taken along section line 4-4 in FIG. 1, according to some embodiments.

FIG. 5 is a detail view of the extrusion device shown in FIG. 4.

FIG. 6 is an exploded rear perspective view of the extrusion device shown in FIGS. 1-5, according to some embodiments.

FIG. 7 is a rear perspective view of a drive assembly and an engagement mechanism shown in the embodiment of FIGS. 3-5, according to some embodiments.

FIG. 8 is an exploded rear perspective of an anti-rotation mechanism and a drive mechanism of the extrusion device shown in FIGS. 3-5 and 7, according to some embodiments.

FIG. 9 is a front view of the anti-rotation mechanism and the drive mechanism of the extrusion device shown in FIGS. 3-5 and 7, taken along line 9-9 in FIG. 8, according to some embodiments.

FIG. 10 is a front view of the anti-rotation mechanism and the drive mechanism of the extrusion device shown in FIGS. 3-5 and 7, taken along line 9-9 in FIG. 8, according to some embodiments.

FIG. 11 is a front view of the anti-rotation mechanism and the drive mechanism of the extrusion device shown in FIGS. 3-5 and 7, taken along line 9-9 in FIG. 8, according to some embodiments.

### DETAILED DESCRIPTION

In the following detailed description, numerous specific details are set forth to provide a full understanding of the subject technology. It should be understood that the subject technology may be practiced without some of these specific details. In other instances, well-known structures and techniques have not been shown in detail so as not to obscure the subject technology.

Further, while the present description sets forth specific details of various embodiments, it will be appreciated that the description is illustrative only and should not be construed in any way as limiting. Additionally, it is contemplated that although particular embodiments of the present inventions may be disclosed or shown in the context of hand-held extrusion devices, such embodiments can be used in various devices that utilize screw-type drive mechanisms and/or other hand-held devices. Furthermore, various applications of such embodiments and modifications thereto, which may occur to those who are skilled in the art, are also encompassed by the general concepts described herein.

In accordance with some embodiments, the present application discloses various features and advantages of an extrusion device that can be used for 3D drawing by a user. The device can be held by the user using only a single hand or more than one hand. The extrusion device can shaped as a pen that can be held in a hand of a user and manipulated to extrude a melted filament and arrange the extruded material of the melted filament free-hand to create 3D structures.

Further, in accordance with some embodiments is the realization that in using a 3D drawing device, the user should focus as much as possible on controlling the position, spacing, and shape of an extruded filament when creating of the 3D structure and less on operating the extrusion device. Accordingly, the present application addresses several operational challenges encountered in prior extrusion devices and provides numerous improvements that enable the user to more effortlessly control operation of the device, thereby allowing the user to exert more control over position, spacing, and shape of the extruded material when creating the 3D structure.

The extrusion device can comprise an elongate body having a first end section and a second end section that is opposite the first end section. The first end section can comprise an inlet having an opening into an internal cavity of the extrusion device. The inlet permits a filament to be inserted through the opening into the extrusion device. Within the extrusion device, the filament can be advanced and melted until it is extruded from an outlet of the device. In some embodiments, the outlet is located at the second end section of the extrusion device.

The extrusion device can comprise a housing. The housing can define an outer surface or profile of the extrusion device. The housing can provide a surface that permits a user to grasp the extrusion device in a hand like a pen. The housing can comprise a tubular body forming an inner cavity. Components of the extrusion device can be retained or positioned within or coupled to the housing.

The housing can comprise a portion of the extrusion device extending between the first end section and the second end section. Optionally, the housing can extend from the first end section to the second end section of the extrusion device. The housing can comprise a single elongate body or one or more separate portions that are coupled together to form the body. For example, the housing can comprise a front portion, a central portion, and a rear portion connected along a longitudinal axis to form the housing. In some embodiments, the housing can have a first portion and a second portion separated along a longitudinal axis between the first end section and the second end section, and configured to mate together like a shell.

The extrusion device can comprise one or more actuators to control an operation of the device. In some embodiments, an actuator can be configured to control a rate of advancement of a filament along the travel path, a level of heat of a heater, a speed of a motor, a direction of movement of a filament through the extrusion device, and/or turn power to the device on or off. In some embodiments, the extrusion device comprises a plurality of actuators.

In some embodiments, an actuator can comprise a button, a knob, and/or a sensor. For example, one or more actuators can be positioned on or within the extrusion device so that operation of the actuator is accessible to a user before, during, and/or after operation of the extrusion device. In some embodiments, the extrusion device can have one or more actuators positioned at a front or rear portion of the device to control filament speed, filament direction, a rate of extrusion, and/or a heat level setting of the heater.

In some embodiments, the extrusion device can optionally comprise a feedback system to convey a status or parameter of the extrusion device or its operation. In some embodiments, the feedback system can convey or receive information and or commands. The extrusion device can have a display or screen. In some embodiments, the extrusion device can optionally comprise indicia of operational parameters. The extrusion device can comprise a range of number, letters, words, a tapered bar, and/or dots relates a parameter the device.

For example, a portion of the housing adjacent to a rotatable actuator can comprise indicia as explained above, and the rotatable actuator can comprise a line or arrow to indicate an indicia corresponding to a position of the rotatable actuator. In some embodiments, the feedback system can be configured to receive or convey information without visual confirmation. For example, the extrusion device can comprise one or more indicia comprising a recess, groove, and/or ridge that can be felt by touching the indicia. In some embodiments, the feedback system can audibly receive or convey information or commands.

Further, the extrusion device can comprise a cover member or actuation component that can provide a location for a user to grasp the device with a hand or finger, provide an ergonomic grip, or facilitate orientation of the extrusion device when grasped by a user. The cover member can extend adjacent to or over a portion of the housing. Optionally, the cover member can be positioned between one or more portions of the housing. For example, the cover member can comprise a central section of the housing that is interposed between front and rear portions of the housing.

In some embodiments, the cover member is a band that extends around the circumference of the extrusion device. The cover member can comprise a portion or surface that is flexible or resilient relative to the housing or another portion of the extrusion device. For example, at least a portion of the cover member can comprise rubber, silicone, and/or other material.

In some embodiments, the cover member can also comprise an actuator or be configured to interact with an actuator to control an operation of the extrusion device. For example, the cover member can comprise one or more actuation surfaces configured to interact with an actuator. The cover member can comprise, for example, a shape, profile, and/or material, configured to aid in reducing user fatigue, facilitate orientation of the device by a user, or reduce heat transfer between the extrusion device and a user.

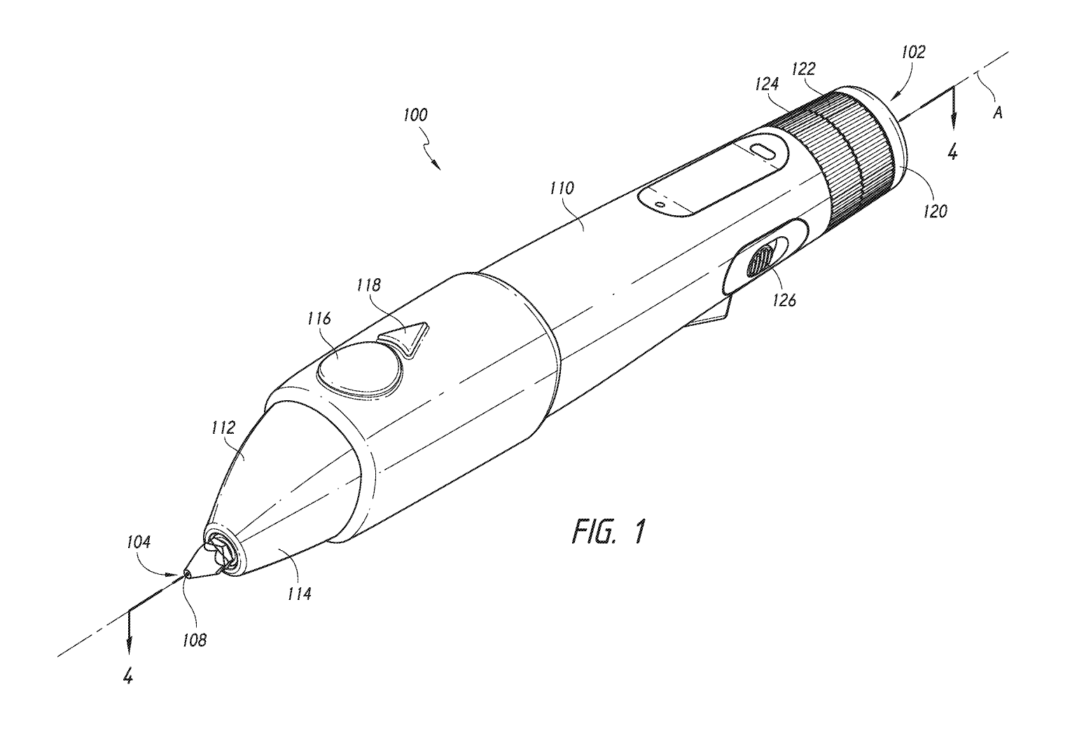

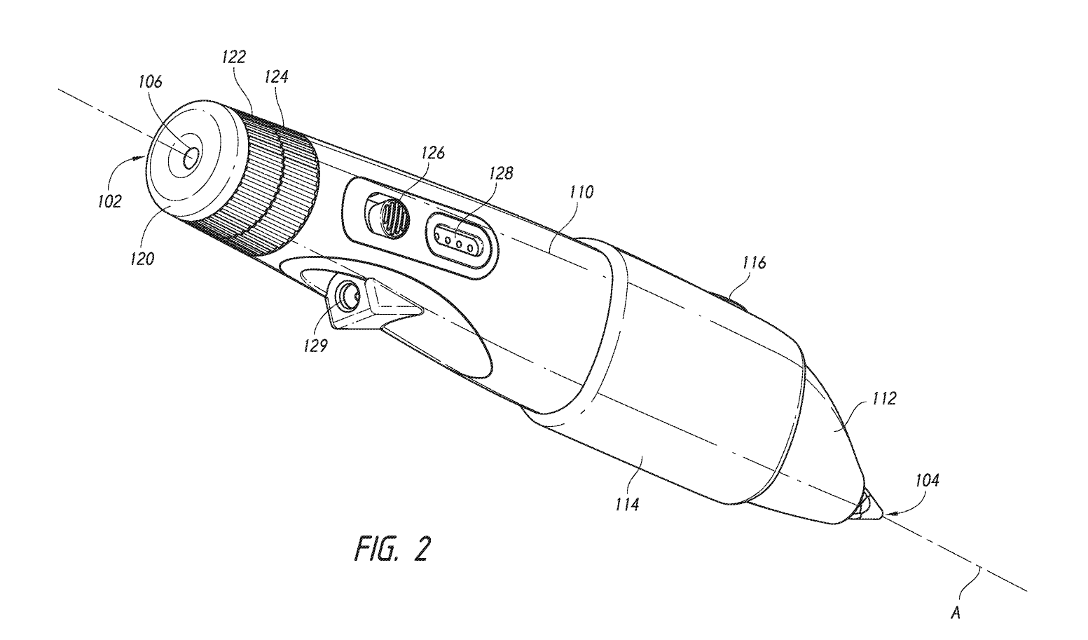

Referring now to the figures, FIGS. 1 and 2 illustrate front and rear perspective views of an embodiment of an extrusion device 100. The extrusion device 100 can have a first end section 102, and a second end section 104, that is opposite the first end section. The first end section 102, or at least a portion thereof, can comprise an inlet 106, and the second end section, or at least a portion thereof, can comprise an outlet 108. A longitudinal axis A can extend through the extrusion device, the inlet 106, and the outlet 108. The housing can comprise one or more portions, including a rear housing 110 extending along the first end section 102, and a front housing 112 extending along the second end section 104.

A cover member 114 extends around the circumference of the extrusion device 100, and can be positioned between the rear housing 110 and the front housing 112. A portion of the cover member 114 can comprise a first actuation surface 116 and a second actuation surface 118, as illustrated in FIG. 1. The first and second actuation surfaces 116, 118 comprise a convex surface that protrudes or extends outwardly relative to the adjacent surfaces of the cover member.

For example, each actuation surface can extend from an outer surface of the cover member to form a raised feature of the cover member. However, the actuation surface can comprise a concave surface, a groove, a ridge, a notch, or any combination thereof. As discussed and illustrated further herein, the cover member 114 can be configured such that the first and second actuation surfaces 116, 118 overlie or are operably coupled to actuators configured to control one or more operations of the extrusion device 100.

The extrusion device 100 can comprise a cap 120 that can form a portion of the first end section 102. The cap 120 can have an outer perimeter profile corresponding to an outer profile of the housing adjacent to the cap 120. Optionally, the cap 120 can have an outer perimeter profile corresponding to a moveable member adjacent to the cap 120. The cap 120 can also comprise an opening or passage that includes a portion of the inlet 106 of the extrusion device 100.

The extrusion device 100 can comprise one or more moveable members, configured to rotate relative to the longitudinal axis A, including a first knob 122 and a second knob 124. The first and second knobs are positioned at a portion of the extrusion device 100 near the first end section 102. The first knob 122 and the second knob 124 are positioned adjacent to each other, and have an outer circumferential surface that is adjacent to an outer surface of the extrusion device 100. In some embodiments, the outer circumferential surface of the first and second knob is flush with the rear housing 110 and the cap 120. Further, the extrusion device 100 can comprise a switch 126, a port 128, and/or a power receptacle 129.

Some embodiments of the extrusion device 100 can comprise an inner cavity having systems or components of the extrusion device 100 therein. For example, the extrusion device 100 can comprise a drive system, a control system, a cooling system, and/or a frame.

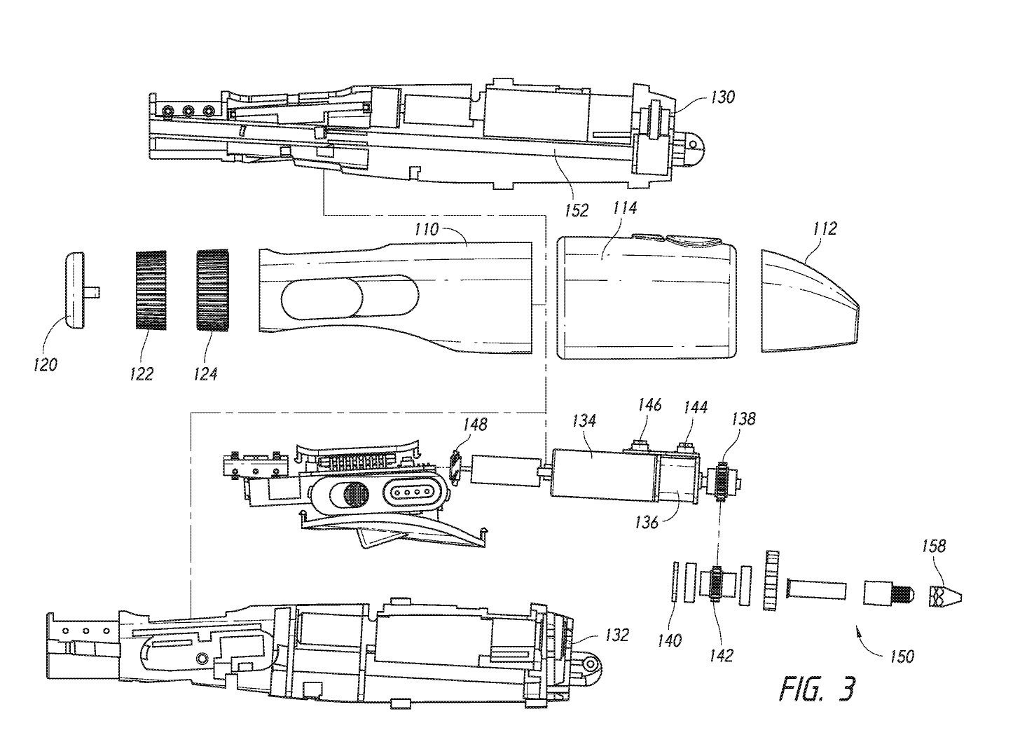

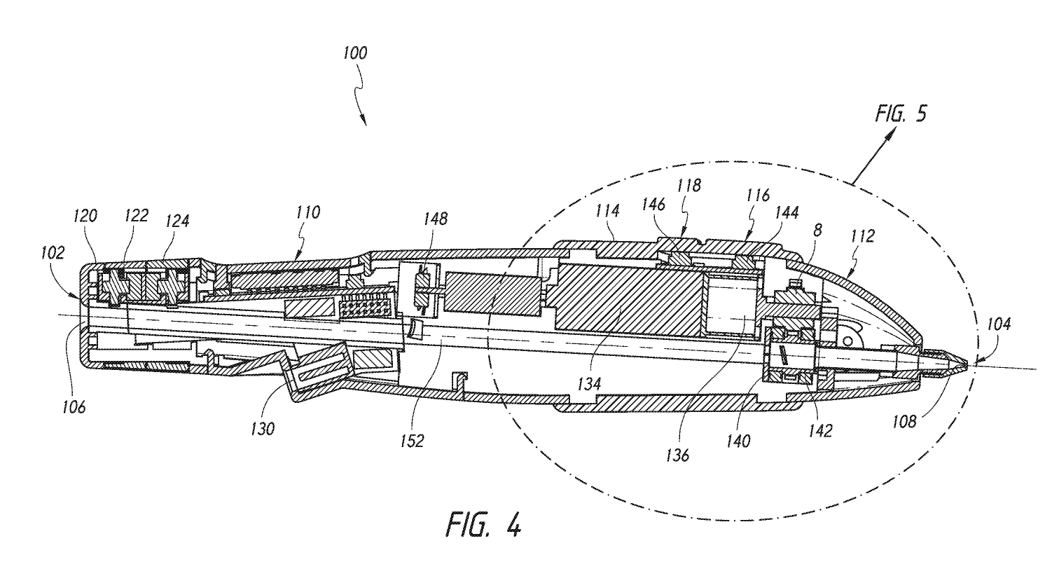

Referring to FIGS. 3 and 4, the extrusion device 100 can comprise a housing that has an inner cavity. The housing can comprise a rear housing 110, a front housing 112, and in some embodiments, a central portion or cover member 114. The device 100 can also comprise a first knob 122, a second arm 124, and a cap 120. An inner cavity of the extrusion device 100 can comprise, but is not limited to, a first frame member 130, a second frame member 132, a motor 134, a gear train 136, and intermediate gear 138, and anti-rotation mechanism 140, a drive mechanism 142, a first actuator 144, a second actuator 146, a cooling fan 148, and/or a heater 150.

The extrusion device 100 can also define a filament travel path to direct a filament through the extrusion device 100 between the inlet 106 and the outlet 108. To define the filament travel path, the device 100 can comprise a tube, a component, and/or surface of the extrusion device 100 that each provides a continuous, elongate opening or pathway wherethrough the filament can be urged. The filament travel path can extend through, for example, the inlet, the housing, the drive mechanism, the heater, and/or the outlet. In some embodiments, a portion of the filament travel path can comprise a surface or recess of a component, such as the housing or the frame.

For example, as illustrated in FIG. 3, the first frame member 130 and the second frame member number 132 can comprise a recess extending between a first end and a second end to define a portion of the filament travel path 152. Although the filament travel path 152 is illustrated in FIG. 4 as a straight line extending along or coaxially with the longitudinal axis A, the filament travel path 152 can deviate from the longitudinal axis A between the inlet 106 and the outlet 108 of the extrusion device 100. The filament travel path 152 can be defined as the pathway along which a filament moves between the inlet 106 and the outlet 108.

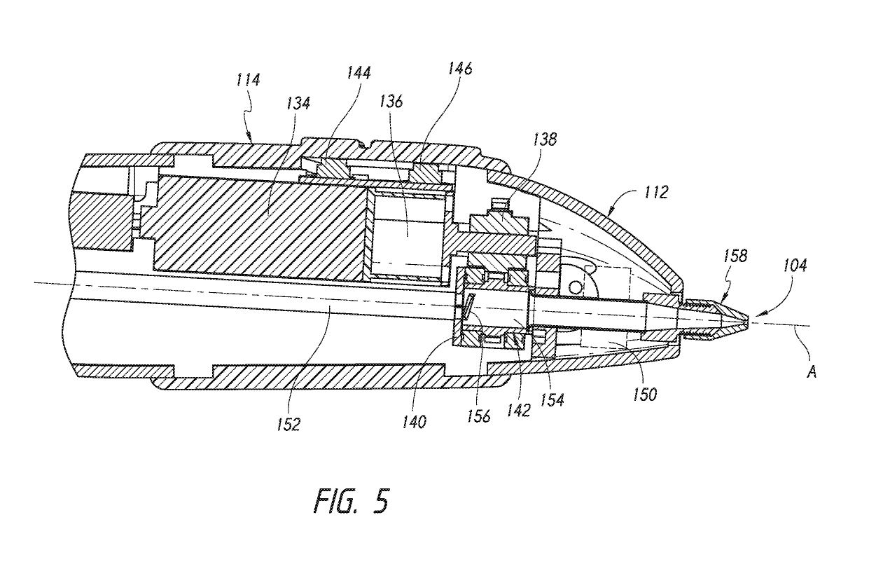

Referring to FIG. 5, the extrusion device 100 can comprise a drive mechanism 142 for engaging and urging a filament along the travel path. The drive mechanism 142 can move a filament relative to the drive mechanism. The drive mechanism 142 can comprise a body having an axis of rotation and a passage 154. In some embodiments, the passage 154 is aligned with the axis of rotation.

In some embodiments, the drive mechanism 142 can comprise a drive protrusion 156 extending from an inner surface of the drive mechanism into the passage 154. The drive protrusion 156 can be configured to engage a filament and move the filament through the drive mechanism.

Further, in some embodiments, the drive protrusion 156 can comprise a portion of a helical thread. In use, rotation of the drive protrusion 156 is able to convey longitudinal motion to the filament by engaging or contacting an outer surface of the filament along a generally helical contact path, similar to that of a helical thread. For example, the engagement or contact between the drive protrusion 156 and the outer surface of the filament can be sufficient to allow the drive protrusion 156 to cut or slice into the surface while being able to slide therealong. Thus, as the drive protrusion 156 rotates, it can slide along the outer surface in a generally diagonal or helical direction such that continued rotation urges the filament in a longitudinal direction.

In some embodiments, the extrusion device 100 can comprise two opposing protrusions that are separated along the axis of rotation. Optionally, the drive protrusion 156 can comprise one or more threads extending through the passage 154. For example, the drive protrusion 156 can comprise a helically threaded portion, such as a female or male threaded tubular portion. Thus, the drive mechanism 142 can comprise an internally threaded tubular member or an externally threaded screw such as, for example, any of those disclosed in U.S. patent application Ser. No. 14/586,812 or 15/167,722, the entirety of each of which is incorporated herein by reference.

An outer surface of the drive mechanism 142 can be configured as a gear having teeth for engagement with the intermediate gear 138 to direct rotation of the drive mechanism. For example, movement of the motor 134 and the gear train 136 rotate the intermediate gear 138. The rotational movement of the intermediate gear 138 can be transferred to the drive mechanism 142 to move a filament relative to the drive mechanism.

The drive mechanism 142 can be positioned adjacent to the filament travel path 152 between the inlet 106 and the outlet 108 so that a filament engages with the drive protrusion 156 and is moved through the passage 154 of the drive mechanism. In some embodiments, the passage 154 of the drive mechanism 142 is positioned parallel or adjacent the filament travel path 152. To facilitate movement of a filament by the drive mechanism 142, an anti-rotation mechanism 140 can be disposed along the filament travel path 152 adjacent to the drive mechanism 142.

A heater 150, illustrated schematically in FIG. 5, can melt a filament to facilitate extrusion of the filament through the outlet 108. The heater 150 can comprise a heating element that generates heat that can be conducted to a filament. The heater 150 can be disposed between the drive mechanism 142 and the outlet 108 to receive the filament from the drive mechanism. The heater 150 can be positioned so that a filament can be moved into a portion of the filament travel path 152 where heat generated by the heater 150 is conducted to the filament. For example, the heater 150 can be positioned along the filament travel path 152 between the drive mechanism 142 and the output 108 so that a filament is moved by the drive mechanism 142 into the heater 150 where it is melted.

A nozzle 158 can be positioned adjacent the filament travel path 152 to receive and direct the melted filament out of the extrusion device 100. The nozzle 158 can comprise a passage that tapers from a first end to a second end so that a filament is extruded having a cross-sectional thickness that is less than a cross-sectional thickness of the filament travel path 152. The nozzle passage can have a cross-sectional profile so that the melted filament has a cross-sectional profile comprising a shape, for example, a circle, a square, a star, and/or any other shape profile.

The cover member 114 can facilitate or guide placement of a user's hand(s) and/or fingers when supporting the extrusion device 100. For example, the cover member 114 can facilitate accessibility to an actuator or actuator surface by the user's hand or finger. The cover member 114 can have an outer surface or profile that facilitates an optimal positioning of the extrusion device 100 within a user's hand (e.g., grip). Further, the cover member 114 can reduce fatigue of a user supporting the extrusion device 100. For example, the cover member 114 can be positioned between the first end section 102 and the second end section 104 of the extrusion device 100 so that the extrusion device 100 is balanced within a user's hand.

An outer surface of the cover member 114 can have a cross-sectional profile or shape that facilitates optimal position of a user's hand on the extrusion device 100. For example, a profile of the cover member 114 can have an elliptical cross-sectional profile so that a user's thumb can engage a portion of the cover member having a smaller radius, while a reminder of the user's fingers can engage a portion of the cover member opposite the smaller radius having a larger radius. Optionally, the extrusion device 100 can comprise a power receptacle 129 on an outer surface opposite of the actuator surface.

The cover member 114 can have a surface that extends along a circumference of the extrusion device 100 relative to the longitudinal axis A. In some embodiments, the cover member 114 can extend along a portion of the circumference or the outer surface of the extrusion device 100. The cover member 114 can have a longitudinal length between the first end section 102 and the second end section 104 of the extrusion device 100. In some embodiments, the cover member 114 has a longitudinal length that extends along a portion of the extrusion device 100 between the rear housing 110 and the front housing 112.

The cover member 114 can comprise one or more actuating and non-actuating portions. For example, an actuating portion or surface of the cover member 114, or at least a portion thereof, can comprise a material that is more flexible or resilient compared to the housing, non-actuating portions of the cover member 114, or other portions of the extrusion device 100. An actuating portion of the cover member 114 can be positioned over or in communication with one or more actuators of the extrusion device 100, as shown in FIG. 5. In some embodiments, the cover member 114 can comprise a silicone band that deflects when squeezed or depressed. For example, as shown in FIG. 5, the cover member 114 can comprise raised or protruding features that, when depressed, can communicate with or control one or more actuators 144, 146 that determine an operation of the extrusion device 100.

For example, a portion of the cover member 114 can have an actuation surface configured to interact with an actuator to control an operation of the extrusion device 100. In some embodiments, the actuation surface can comprise a portion of an outer surface of the cover member 114 having a concave or convex surface.

For example, the actuation surface, or in some embodiments, the entire cover member 114 can comprise a material that is flexible or resilient relative to other components of the extrusion device 100. Optionally, the actuation surface or a portion of the cover member 114 surrounding the actuation surface can be more flexible than non-actuating sections of the cover member 114. Thus, in some embodiments, the actuation surface can be formed from a continuous piece of material with other portions of the cover member 114.

Further, in some embodiments, the cover member 114 can comprise more than one actuation surface. The actuation surface can be positioned adjacent to or overlapping an actuator. When the actuation surface is engaged or depressed by a user, a portion of the cover member 114 can engage an adjacent actuator to control an operation of the extrusion device 100.

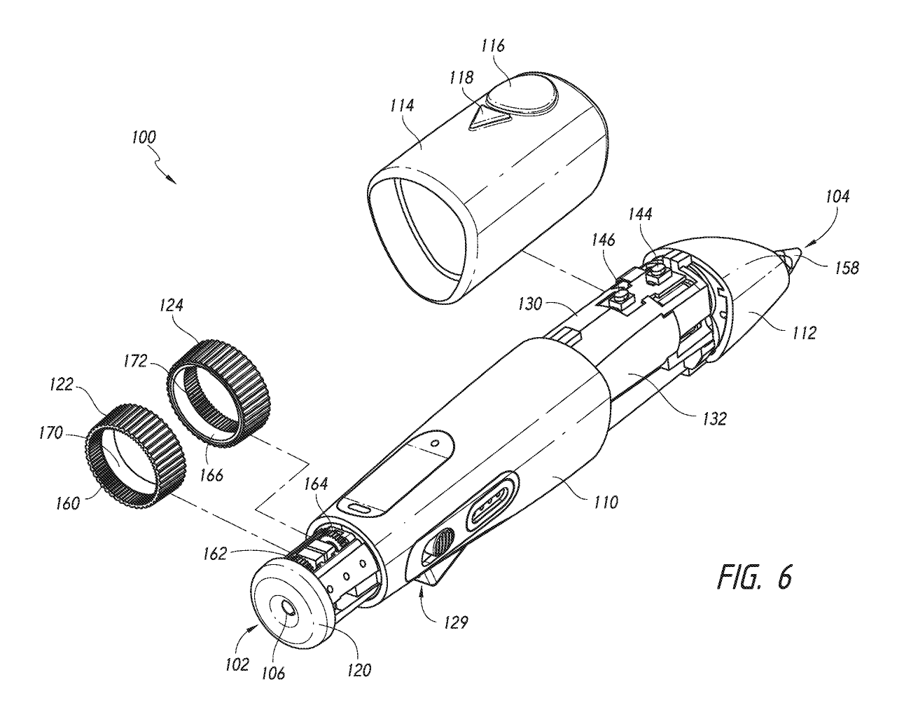

FIG. 6 illustrates a partially exploded view of an embodiment of a cover member 114 separated from other components of the extrusion device 100. The cover member 114 comprises a tubular shape having a length extending along the longitudinal axis A of the extrusion device 100. The length of the cover member 114 is less than a length between the inlet 106 and the outlet 108 of the extrusion device 100. The cover member 114 can extend around a circumference of the extrusion device 100 between the rear housing 110 in the front housing 112. The cover member 114 can comprise a first actuation surface 116 and a second actuation surface 118 positioned to overlap a first actuator 144 and a second actuator 146, respectively. Optionally, the cover member 114 can retain, couple, or secure one or more components of the housing relative to each other or the cover member 114. For example, the cover member 114 can retain a first half and a second half of the housing, and/or the first frame member 130 and the second frame member 132.

The extrusion device 100 can comprise an extrusion control mechanism comprising one or more movable members to control an operation of the device. In some embodiments, a movable member can be configured to engage an actuator to control an operation of the device, such as changing a rate of extrusion of the filament, a filament heat level of the heater, activation of a motor, a motor speed, and/or a direction of filament movement through the extrusion device 100. The movable member can also provide indicia of the configuration or a setting of the extrusion device 100.

In some embodiments, the movable member can comprise one or more moveable members having a common axis of rotation. The axis of rotation can be aligned with the longitudinal axis A, parallel to the longitudinal axis A, or aligned with another axis of the extrusion device.

The moveable member can have an outer surface defining a cross-sectional profile that corresponds with a cross-sectional profile of the extrusion device. For example, an outer surface of the moveable member, and an outer surface of the housing adjacent to the moveable member can have a continuous profile. In some embodiments, the outer surface of a moveable member comprises a profile corresponding with a profile of an outer surface of an adjacent moveable member. A moveable member can be positioned at a portion of the extrusion device 100 adjacent to the first end section 102. In some embodiments, a moveable member is positioned between the first end section 102 and the rear housing 110. In some embodiments, a moveable member is positioned between the cap 120 and the rear housing 110.

The movable member can include indicia of the configuration or a setting of the extrusion device 100. Indicia related to a configuration or setting of the extrusion device 100 can be represented on the movable member or adjacent to the movable member. For example, the movable member can comprise an arrow, dot, and/or line, and the housing adjacent to the movable member can comprise a series of indicia related to a configuration or setting of the extrusion device 100. When the movable member is moved or rotated, the configuration or setting of the extrusion device 100 can be identified by an alignment of the arrow, dot, and/or line with the indicia.

In some embodiments, the movable member can have an irregular outer surface to facilitate a user's grip on the movable member or to facilitate identification of a position of the movable member. For example, an outer surface of the movable member and/or the housing can have one or more grooves, notches, and/or ridges.

The movable member can be in operative communication with an actuator of the extrusion device 100 so that movement or rotation of the movable member changes an operation of the extrusion device 100. Optionally, the movable member can be in operative communication with a potentiometer. In some embodiments, the movable member rotatable about an axis of rotation can provide incremental control over a range of operations of the extrusion device 100.

FIG. 6 illustrates an embodiment of the extrusion control mechanism of the extrusion device 100 having a pair of movable members, shown as a first knob 122 and a second knob 124. The first and second knobs 122 and 124 are tubular shaped and have first and second ends. Optionally, the first and second knobs 122 and 124 can comprise longitudinal grooves or ridges extending around a perimeter of an outer circumferential surface.

A portion of an inner surface of the first and second knob 122 and 124 can comprise grooves or ridges configured to engage with an actuator to control an operation of the device. A portion of an inner surface of the first and second knob 122 and 124 can comprise a surface configured to align the first and second knob 122 and 124 on the extrusion device 100 and permit rotation of the first and second knob 122 and 124.

A first portion 160 of an inner surface of the first knob 122 can extend from the first end toward the second end and comprise grooves or ridges along a perimeter of the inner surface to engage with a first knob gear 162 of an actuator. A second portion 170 of the inner surface of the first knob 122 can extend from the first portion 160 to the second end and comprise a smooth surface configured to permit rotation of the first knob 122 around the longitudinal axis A, relative to the extrusion control mechanism.

Similarly, a first portion 166 of an inner surface of the second knob 124 can extend from the first end toward the second end and comprise a smooth surface configured to permit rotation of the second knob 124 around the longitudinal axis A, relative to one or more other portions of the extrusion device and/or control mechanism. A second portion 172 of the inner surface of the second knob 124 can extend from the first portion 166 to the second end and comprise grooves or ridges along a perimeter of the inner surface to engage with a second knob gear 164 of an actuator.

In some embodiments, the first and second knobs 122 and 124 are positioned adjacent to each other between the rear housing 110 and the inlet end 102. Referring to an embodiment illustrated in FIG. 4, each of the first and second knobs 122 and 124 comprise an outer surface that tapers between the first and second ends. More specifically, the second knob 124 comprises an outer surface defining a cross-sectional profile that corresponds with the rear housing 110 adjacent to the second end of the second knob 124. The outer surface of the second knob 124 can taper from the second end toward the first end. Referring now to the first knob 122, an outer surface defining a cross-sectional profile of the first knob 122 corresponds with the first end of the adjacent second knob 124. The first knob 122 outer surface tapers from the second end toward the first end. Accordingly, a cross-sectional profile of both the first and second knobs 122 and 124 comprise an outer surface that tapers from the second end of the second knob 124 toward the first end of the first knob 122.

Although a movable member has been described herein as rotatable, a movable member can, optionally, pivot or slide relative to the housing or another component of the extrusion device 100.

As noted above, the drive mechanism can rotate and convey longitudinal motion to the filament by engaging or contacting an outer surface of the filament. Indeed, as the drive mechanism rotates, it can slide along the outer surface in a generally diagonal or helical direction such that continued rotation urges the filament in a longitudinal direction. However, in some circumstances, resistance to longitudinal movement of the filament may be greater than or equal to resistance to rotational movement of the filament relative to the housing. Thus, instead of moving longitudinally, the filament can instead engage with the drive protrusion and be rotated within the filament travel path. Even if this occurs sporadically, such rotation of the filament can disrupt the control and accuracy of the extrusion device during use. This disruption can lead to unpredictable extrusion rates and user dissatisfaction.

Accordingly, as noted above, some embodiments disclosed herein incorporate novel and advantageous features that overcome at least some of the challenges noted herein. In particular, some embodiments incorporate an anti-rotation mechanism that engages the filament to provide a frictional and/or mechanical contact that exceeds the filament's resistance to longitudinal movement. The filaments resistance to longitudinal movement can be defined as that encountered upstream of the heater mechanism, such as that created due to contact between the filament and components disposed along the filament travel path. Accordingly, the anti-rotation mechanism can engage with the filament sufficient to restrict or prevent rotation of the filament when engaged with a rotary drive mechanism.

For example, referring again to the figures, in some embodiments, the extrusion device 100 can comprise an anti-rotation mechanism to restrict rotational movement of a filament moving longitudinally through the anti-rotation mechanism. Restricting movement of the filament facilitates the drive mechanism to move the filament through the extrusion device 100.

The anti-rotation mechanism can comprise a body comprising a passage to permit a filament to move therethrough. The passage comprises an inner surface defining a cross-sectional profile that is approximately equal to or greater than an outer surface profile of a filament. In some embodiments, the anti-rotation mechanism comprises a tubular body. Optionally, the passage through the anti-rotation mechanism can comprise one or more components of the extrusion device. For example, the passage can comprise a portion of the frame or housing.

The anti-rotation mechanism can be positioned adjacent to the filament passage so that a filament being moved through the extrusion device 100 is moved through the passage of the anti-rotation mechanism. In some embodiments, the anti-rotation mechanism is positioned adjacent to a drive mechanism. The anti-rotation mechanism can be positioned between the inlet 106 and the drive mechanism 142.

The anti-rotation mechanism can comprise a filament-engaging component to restrict movement of a filament moving through the anti-rotation mechanism. The filament engaging can comprise a contacting portion positioned adjacent to the travel path to restrict rotation of a filament within the travel path as the filament moves by the anti-rotation mechanism. The filament-engaging component can restrict rotation of a filament along a longitudinal axis of the filament as a filament moves through the anti-rotation mechanism. Rotation of the filament can be restricted relative to the anti-rotation mechanism, relative to rotation of the drive mechanism, relative to the housing, and/or relative to another component of the extrusion device 100.

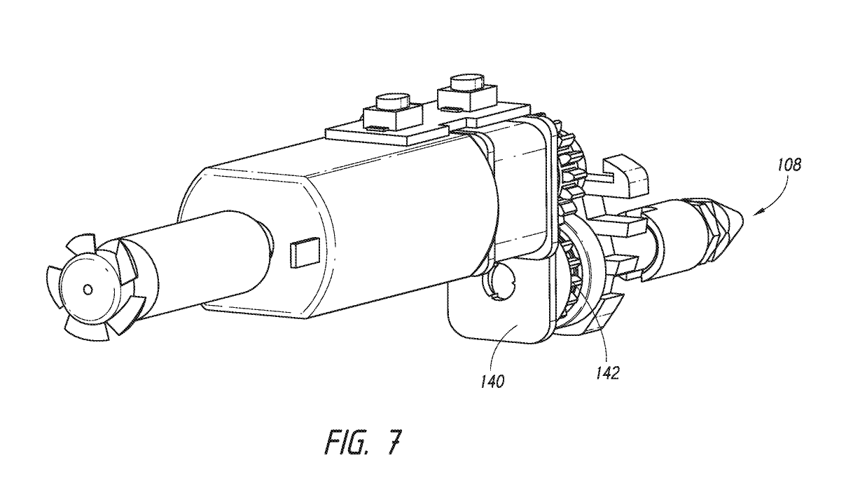

Referring to FIG. 7, an anti-rotation mechanism 140 is illustrated positioned adjacent to the drive mechanism 142. The anti-rotation mechanism 140 and the drive mechanism 142 are positioned along a filament travel path so that a filament moving through the extrusion device 100 moves through a passage of the anti-rotation mechanism 140 and the drive mechanism 142. In some embodiments, as a filament is inserted into the inlet 106 of the extrusion device 100 and moved toward the outlet 108, the filament moves through the anti-rotation mechanism 140 and then the drive mechanism 142.

According to some embodiments, movement or rotation of the drive mechanism 142 in a first direction can draw the filament through the anti-rotation mechanism 140 toward the outlet 108. A movement or rotation of the drive mechanism 142 in a second direction can push the filament through the anti-rotation mechanism toward the inlet 106. Thus, according to some embodiments, the filament can move past or be engaged by the anti-rotation mechanism 140 whether the filament is advanced toward or retracted from the outlet 108.

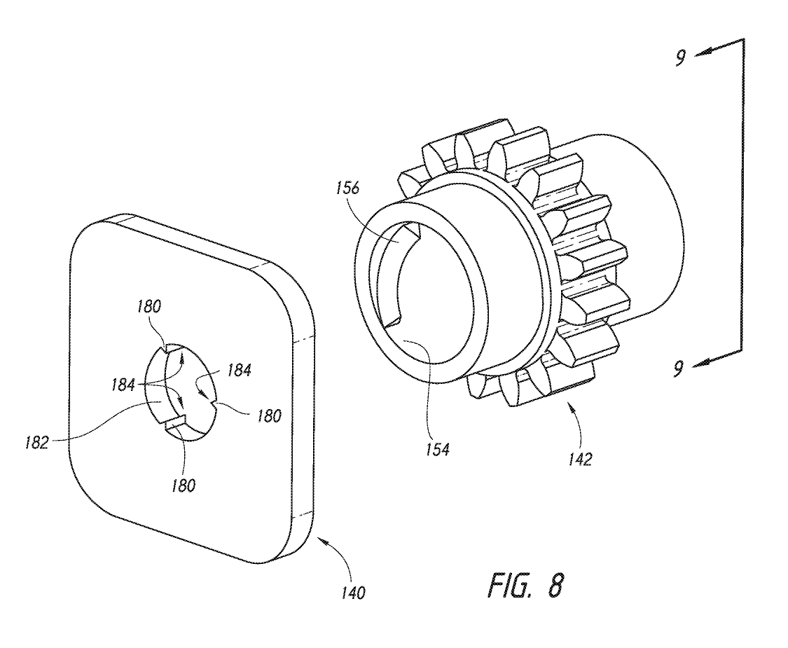

FIGS. 8-11 illustrate various features of filament-engaging component(s) of anti-rotation mechanisms, according to some embodiments. Referring to FIG. 8, the filament-engaging component 180 can extend from the anti-rotation mechanism 140 toward a central axis of a passage 182 through the anti-rotation mechanism 140. In some embodiments, a plurality of filament-engaging components 180 can extend from the anti-rotation mechanism 140 into the passage 182. In some embodiments, the filament-engaging component 180 is a radial protrusion extending from the anti-rotation mechanism 140 into the passage 182.

A filament-engaging component 180 can have a length extending from a proximal end coupled to the anti-rotation mechanism 142 to a distal end in the passage 182. The filament-engaging component 180 can have a cross-section that tapers from the proximal end toward the distal end. The distal end of the filament-engaging component 180 can comprise a contacting portion 184 configured to engage an outer surface of a filament positioned within the passage 182 of the anti-rotation mechanism 140. The contacting portion 184 can frictionally contact, rub, scratch, slice, or pierce into an outer surface of a filament so that contacting portion frictionally contacts and/or physically extends into the filament. In some embodiments, the contacting portion 184 and a portion of the filament-engaging component 180 can extend into the filament. Such engagement or contact can create a frictional or physical engagement force that is greater than the friction between the drive protrusion(s) and the outer surface of the filament. As such, the resistance to rotation can exceed the rotational force exerted by the rotary drive mechanism and tend to ensure a more efficient translation of rotational movement of the drive mechanism to longitudinal movement of the filament.

The filament-engaging component 180 can have first and second ends. The filament-engaging component 180 and contacting portion 184 can extend parallel relative to the travel path 152. In some embodiments, the filament-engaging component 180 extends parallel relative to the central axis of a passage 182. Optionally, the filament-engaging component 180 can comprise a conical shape, tapering from a proximal end toward a distal end.

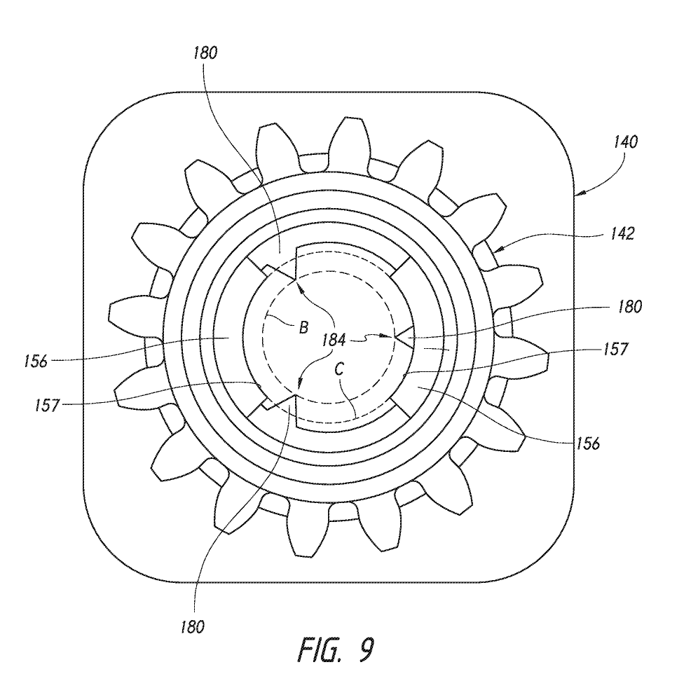

Referring to FIG. 9, some embodiments of the extrusion device 100 comprise a plurality of filament-engaging components 180 that extend from the anti-rotation mechanism 140 toward a central axis of the passage of the anti-rotation mechanism. An opening between the contacting portions 184 can have a filament-engaging cross-sectional profile identified by the dashed line B. The filament-engaging cross-sectional profile is smaller than a cross-sectional profile of a filament. Due to the relative size between the filament-engaging cross-sectional profile and the cross-sectional profile of a filament, a portion of a filament-engaging component 180 can pierce an outer surface of a filament extending through the passage 182.

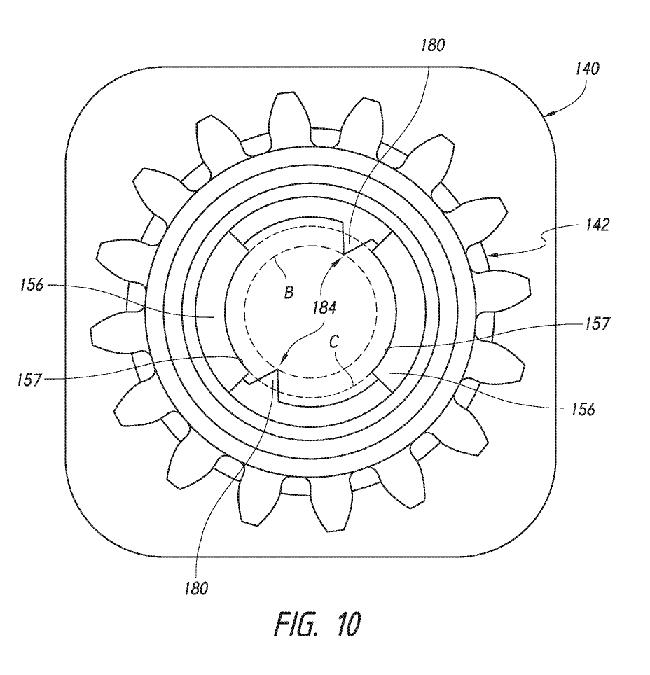

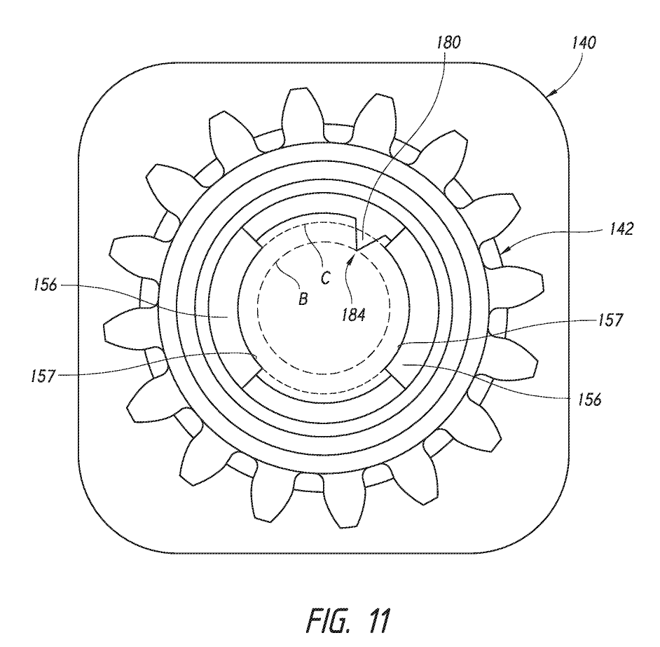

In some embodiments, the anti-rotation mechanism 140 can comprise more than one filament-engaging component 180, as illustrated in FIG. 9. In some embodiments, the anti-rotation mechanism 140 comprises two filament-engaging components 180, as illustrated in FIG. 10. The filament-engaging components 180 can be equally spaced around the central axis or offset around the central axis of the passage 182. In some embodiments, the anti-rotation mechanism 140 comprises one filament-engaging component 180, as illustrated in FIG. 11.

In some embodiments, a distance from a contacting portion 184 to an opposing surface of the anti-rotation mechanism can be less than a cross-sectional distance between opposing outer surfaces of the filament so that a portion of a filament-engaging component 180 can pierce an outer surface of a filament extending through the passage 182. Thus, in positioning or advancing the filament into the opening of the anti-rotation mechanism 140, the filament can contact the contacting portion 184 at a first side or section of the filament circumference and contact or abut a perimeter of the opening at and opposing second side or section of the filament circumference. As such, the filament, when inserted through the opening of the anti-rotation mechanism 140 can have a cross-sectional profile that is greater than a cross-sectional clearance through the opening of the anti-rotation mechanism 140, thus ensuring that the filament will be substantially always contacted by the contacting portion 184 of the anti-rotation mechanism 140.

Further, although the outer or cross-sectional profile of the filament may change along its length, the cross-sectional clearance through the opening of the anti-rotation mechanism 140 can be sized to accommodate a given filament cross-sectional shape or diameter with a tolerance for some variation in the cross-sectional profile thereof.

Furthermore, in order to accommodate different filament sizes and shapes, some embodiments can be provided in which the extrusion device comprises an interchangeable drive assembly or anti-rotation mechanism or various versions of extrusion devices can be provided.

Optionally, the filament-engaging component 180 can have a cross-sectional profile that tapers toward a central axis thereof in the direction of the outlet 108. For example, the filament-engaging components cross-sectional profile can taper so as to become closer to the central axis (of the filament travel path or opening of the anti-rotation mechanism 140) in a direction from the inlet 106 toward the outlet 108. In a further example, a filament-engaging cross-sectional profile can be equal to or larger than a cross-sectional profile of a filament at the first end of the filament-engaging component 180, and a filament-engaging cross-sectional profile that is smaller than a cross-sectional profile of a filament at the second end filament-engaging component 180. Thus, as the filament is advanced into the opening of the anti-rotation mechanism 140, the filament-engaging component 180 can be increasingly engaged with or cut increasingly deeper into the filament as the filament advances through the opening.

Referring still to FIGS. 9-11, a drive protrusion 156 extending from the drive mechanism 142 toward a passage 154 of the drive mechanism can have an opening or cross-sectional drive profile identified by dashed line C, which is defined at least partially by an edge 157 of the drive protrusion 156. The cross-sectional drive profile can be approximately equal to or smaller than a cross-sectional profile of a filament. Further, the cross-sectional drive profile is larger than filament-engaging cross-sectional profile. In some embodiments, a distance from a contacting portion 184 to an opposing surface of the anti-rotation mechanism can be less than a cross-sectional distance between opposing inner surfaces of the drive mechanism. For example, a distance from a contacting portion 184 to an opposing surface of the anti-rotation mechanism can be less than a cross-sectional distance between opposing inner surfaces of a drive protrusion 156.

In operation, a filament is moved from the inlet 106 through the travel path 152 toward the anti-rotation mechanism 140. When the filament is moved through the passage 182 of the anti-rotation mechanism, a contacting portion 184 of a filament-engaging component can engage and extend into the filament. In some embodiments, the filament-engaging cross-sectional profile can taper toward the drive mechanism and a contacting portion 184 can engage an outer surface of the filament. However, as the filament is moved through the tapering filament-engaging cross-sectional profile toward the drive mechanism, the contacting portion 184 can pierce an outer surface of a filament.

When the drive mechanism 142 is rotated, a rotational force can be applied to the filament. However, a force opposite to and greater than or at least equal in magnitude to any rotational force applied by the drive mechanism (e.g., the edge 157 of the drive protrusion 156) can be applied by the filament-engaging component(s) 180 to restrict rotation of the filament. This can tend to substantially reduce and/or eliminate the rotational component of the force applied by the drive mechanism and cause the filament to move only longitudinally. Accordingly, the drive mechanism 142 can more efficiently transfer longitudinal movement to the filament, allowing the user greater control and accuracy over the extrusion process.

The foregoing description is provided to enable a person skilled in the art to practice the various configurations described herein. While the subject technology has been particularly described with reference to the various figures and configurations, it should be understood that these are for illustration purposes only and should not be taken as limiting the scope of the subject technology.

There may be many other ways to implement the subject technology. Various functions and elements described herein may be partitioned differently from those shown without departing from the scope of the subject technology. Various modifications to these configurations will be readily apparent to those skilled in the art, and generic principles defined herein may be applied to other configurations. Thus, many changes and modifications may be made to the subject technology, by one having ordinary skill in the art, without departing from the scope of the subject technology.

It is understood that the specific order or hierarchy of steps in the processes disclosed is an illustration of exemplary approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

Terms such as “top,” “bottom,” “front,” “rear” and the like as used in this disclosure should be understood as referring to an arbitrary frame of reference, rather than to the ordinary gravitational frame of reference. Thus, a top surface, a bottom surface, a front surface, and a rear surface may extend upwardly, downwardly, diagonally, or horizontally in a gravitational frame of reference.

Furthermore, to the extent that the term “include,” “have,” or the like is used in the description or the claims, such term is intended to be inclusive in a manner similar to the term “comprise” as “comprise” is interpreted when employed as a transitional word in a claim.

The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather means “one or more.” Pronouns in the masculine (e.g., his) include the feminine and neuter gender (e.g., her and its) and vice versa. The term “some” refers to one or more. Underlined and/or italicized headings and subheadings are used for convenience only, do not limit the subject technology, and are not referred to in connection with the interpretation of the description of the subject technology. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

What is claimed is:

1. An extrusion device comprising:
an inlet, an outlet, and a longitudinal axis between therebetween;
a filament travel path extending along the longitudinal axis;
a drive mechanism disposed along the travel path for engaging and urging a filament along the travel path;
an anti-rotation mechanism disposed along the travel path adjacent to the drive mechanism, the anti-rotation mechanism comprising a filament-engaging component having a contacting portion positioned adjacent to the travel path to restrict rotation of a filament about the travel path as the filament moves by the anti-rotation mechanism; and
a heater disposed between the drive mechanism and the outlet to receive the filament from the drive mechanism.

2. The device of claim 1, wherein the anti-rotation mechanism comprises a tubular body, the contacting portion comprising a radial protrusion extending radially toward the travel path to contact the filament and restrict rotation of a filament relative to the anti-rotation mechanism as the filament moves by the anti-rotation mechanism.

3. The device of claim 1, wherein the contacting portion tapers in cross-section from the filament-engaging component toward the travel path.

4. The device of claim 1, wherein a cross-sectional opening through the filament-engaging component is smaller than a cross-sectional profile of the filament.

5. An extrusion device comprising:
an inlet, an outlet, and a longitudinal axis between therebetween;
a filament-engaging first member configured for moving a filament along a travel path when the first member is rotated;
a filament-engaging second member restricting rotation of the filament relative to the first member as the first member is rotated; and
a heater disposed along a travel path between the filament-engaging first member and the outlet to receive the filament from the filament-engaging first member.

6. The device of claim 5, wherein the travel path extends along the longitudinal axis.

7. The device of claim 5, wherein the filament-engaging second member is disposed along the travel path between the inlet and the filament-engaging first member.

8. The device of claim 5, wherein the filament-engaging second member comprises a contacting portion positioned adjacent to the travel path to restrict rotation of the filament about the travel path as the filament moves by the filament-engaging second member.

9. The device of claim 8, wherein the contacting portion extends parallel relative to the travel path.

10. The device of claim 8, wherein the contacting portion tapers in cross-section from the filament-engaging second member toward the travel path.

11. The device of claim 5, wherein a cross-sectional opening through the filament-engaging second member is smaller than a cross-sectional profile of the filament.

12. The device of claim 5, wherein the filament-engaging second member comprises a tubular body and a contacting portion comprising a radial protrusion extending radially toward the travel path to contact the filament and restrict rotation of a filament relative to the filament-engaging second member as the filament moves by the filament-engaging second member.

13. The device of claim 5, wherein the filament-engaging first member is rotatable around the longitudinal axis.

14. The device of claim 5, wherein the filament-engaging second member comprises at least one surface extending toward the travel path.

15. An extrusion device comprising:
a housing having an inlet, an outlet, and a longitudinal axis between therebetween,
a filament travel path extending along the longitudinal axis;
a drive mechanism disposed along the travel path for engaging and urging a filament along the travel path toward a heater configured to heat the filament; and
an extrusion control mechanism rotatable about an axis and having an outer circumferential surface adjacent to an outer surface of the housing for controlling a rate of extrusion of a filament out of the outlet.

16. The device of claim 15, wherein the extrusion control mechanism is rotatable relative to the housing.

17. The device of claim 15, the extrusion control mechanism is rotatable about the longitudinal axis.

18. The device of claim 15, further comprising a motor, disposed within the housing, in operative communication with the extrusion control mechanism.

19. The device of claim 15, wherein the outer circumferential surface of the extrusion control mechanism extends adjacent to a circumferential surface of the housing.

20. The device of claim 15, wherein the extrusion control mechanism is disposed adjacent to the inlet of the housing.
